(19) United States
(12) Patent Application Publication
(10) Pub. No.: US 2019/0173100 A1
(43) Pub. Date: Jun. 6, 2019

(54) METHOD FOR MANUFACTURING SEPARATOR FOR FUEL CELL

(71) Applicant: TOYOTA JIDOSHA KABUSHIKI KAISHA, Toyota-shi (JP)

(72) Inventors: Hideo NAKAMURA, Toyota-shi (JP); Yuichiro HAMA, Nagoya-shi (JP); Akinori EDA, Nagakute-shi (JP)

(73) Assignee: TOYOTA JIDOSHA KABUSHIKI KAISHA, Toyota-shi (JP)

(21) Appl. No.: 16/209,091

(22) Filed: Dec. 4, 2018

(30) Foreign Application Priority Data
Dec. 5, 2017 (JP) 2017-233814

(51) Int. Cl. H01M 8/0228; H01M 8/026; H01M 8/0206; H01M 8/0213; H01M 8/0221; H01M 8/0226

(52) U.S. Cl. CPC H01M 8/0228; H01M 8/026; H01M 8/0206; H01M 2008/1095; H01M 8/0221; H01M 8/0226; H01M 8/0213

(57) ABSTRACT

A method for manufacturing a separator for fuel cell can hold the shape of slurry applied on the surface of a metal substrate and so form the structure of a predetermined thickness on the surface of the metal substrate. The method includes: a coating removal step to partially remove an oxide coating covering the surface of the metal substrate to form an application part; an applying step to apply slurry at the application part after removing the oxide coating; and a thermal treatment step to heat the slurry applied at the application part to form a conduit-defining part.

### CROSS REFERENCE TO RELATED APPLICATIONS

The present application claims priority from Japanese patent application JP 2017-233814 filed on Dec. 5, 2017, the content of which is hereby incorporated by reference into this application.

### BACKGROUND

### Technical Field

The present disclosure relates to a method for manufacturing a separator for fuel cell.

### Background Art

Conventionally inventions about a method for manufacturing a separator for fuel cell have been known, and such a separator has a gas diffusion layer to supply gas to an electrolyte layer having a catalyst layer on the surface (see JP 2006-331670 A, for example). This patent document describes a method for manufacturing a separator for fuel cell that includes a substrate functioning as a separator of the fuel cell and a gas diffusion layer on the surface of the substrate.

Such a conventional method for manufacturing a separator for fuel cell includes an applying step and a thermal treatment step (see Claim 1, for example, in the above document). The applying step applies metal-powder suspended slurry, which can form a metal porous layer after sintering, on the surface of the substrate. The thermal treatment step heats the substrate with the metal-powder suspended slurry applied in the temperature environment that can form the metal porous layer from the metal-power suspended slurry by sintering so as to form the metal porous layer by sintering.

### SUMMARY

A metal porous layer to be a gas diffusion layer of a fuel cell has to have a predetermined thickness. The above patent document specifically describes the method including screen printing to apply metal-powder suspended slurry. In this case, the metal-power suspended slurry applied on the substrate at the applying step may deform and spread over the surface of the substrate due to the self-weight, and it may be difficult to form a metal porous layer of a necessary thickness at the thermal treatment step.

One aspect of the present disclosure provides a method for manufacturing a metal separator for fuel cell that can hold the shape of slurry applied on the surface of a metal substrate and so form the structure of a predetermined thickness on the surface of the metal substrate.

A method for manufacturing a separator for fuel cell according to one aspect of the present disclosure manufactures a separator for fuel cell including a metal substrate and a conduit-defining part on the surface of the metal substrate. The method includes: partially removing oxide coating covering the surface of the metal substrate to form an application part; applying slurry to the application part after removing the oxide coating; and heating the slurry applied at the application part to form the conduit-defining part.

The method for manufacturing a separator for fuel cell according to this aspect includes the step of partially removing an oxide coating covering the surface of the metal substrate to form an application part. This step makes the wettability at the application part to apply slurry better than the wettability at the oxide coating of the metal substrate surrounding the application part. The application part where the oxide coating on the surface of the metal substrate is removed is slightly recessed from the surface of the oxide coating surrounding the application part.

With this configuration, at the applying step of slurry to the application part after removing the oxide coating, the slurry applied to the application part does not spread over the surface of the surrounding metal substrate for wetting due to the self-weight. In this way, the slurry can keep the shape and height applied to the application part. Subsequently the slurry applied at the application part is heated to form a conduit-defining part, whereby a conduit-defining part having a predetermined shape and height can be formed.

In the method for manufacturing a separator for fuel cell according to the above aspect, the forming of the application part makes a contact angle with pure water at the application part smaller than a contact angle with pure water at the oxide coating, for example. This can make the wettability at the application part to apply slurry better than the wettability at the oxide coating of the metal substrate surrounding the application part.

In the method for manufacturing a separator for fuel cell according to the above aspect, the forming of the application part removes the oxide coating with laser light, for example. This allows laser light to be reflected from a newly formed surface of the metal substrate that is exposed at the application part after removing the oxide coating, whereby the oxide coating on the surface of the metal substrate can be removed by the laser light.

In the method for manufacturing a separator for fuel cell according to the above aspect, the contact angle with pure water at the application part is 0.75 times or less the contact angle with pure water at the oxide coating, for example. This can prevent the slurry applied to the application part from spreading over the surface of the surrounding metal substrate for wetting due to the self-weight. In this way, the slurry can keep the shape and height applied to the application part reliably.

In the method for manufacturing a separator for fuel cell according to the above aspect, the metal substrate is made of pure titanium, and the contact angle with pure water at the application part is less than 20[° ], for example. This can reliably prevent the slurry applied to the application part from spreading over the surface of the surrounding metal substrate for wetting due to the self-weight. In this way, the slurry can keep the shape and height applied to the application part reliably.

In the method for manufacturing a separator for fuel cell according to the above aspect, the metal substrate is made of stainless steel, and the contact angle with pure water at the application part is less than 60[°], for example. This can reliably prevent the slurry applied to the application part from spreading over the surface of the surrounding metal substrate for wetting due to the self-weight. In this way, the slurry can keep the shape and height applied to the application part reliably.

In the method for manufacturing a separator for fuel cell according to the above aspect, the slurry has viscosity of 1×10³[mPa·s] or more and 1×10⁴[mPa·s] or less when shear rate is within the range of 1×10²[l/sec] or less, for example. With this configuration, at the applying step of slurry to the application part, the slurry can be applied by screen printing, and the slurry can keep the shape and height applied to the application part.

The above aspect can provide a method for manufacturing a separator for fuel cell that can hold the shape of slurry applied on the surface of a metal substrate and so form the structure of a predetermined thickness on the surface of the metal substrate.

### BRIEF DESCRIPTION OF THE DRAWINGS

FIG. 1 is a schematic cross-sectional view of a fuel cell;

FIG. 2 is a schematic enlarged plan view of the surface of the separator in FIG. 1;

FIG. 3 is a flowchart of a method for manufacturing a separator for fuel cell according to one embodiment of the present disclosure;

FIG. 4 is a schematic enlarged cross-sectional view of the metal substrate to describe one example of the coating removal step in FIG. 3;

FIG. 5 is a schematic enlarged cross-sectional view of the metal substrate when the applying step in FIG. 3 ends;

FIG. 6 is a graph showing the contact angles with pure water at the oxide coating and at the application part of the metal substrates of Example 1;

FIG. 7 is a graph showing the contact angles with pure water at the oxide coating and at the application part of the metal substrates of Example 2;

FIG. 8 is a graph showing the relationship between the shear rate and the viscosity of the slurry in Examples; and

FIG. 9 is a schematic cross-sectional view of the slurry applied to the metal substrates of Comparative Examples.

### DETAILED DESCRIPTION

The following describes one embodiment of a method for manufacturing a separator for fuel cell according to the present disclosure, with reference to the drawings.

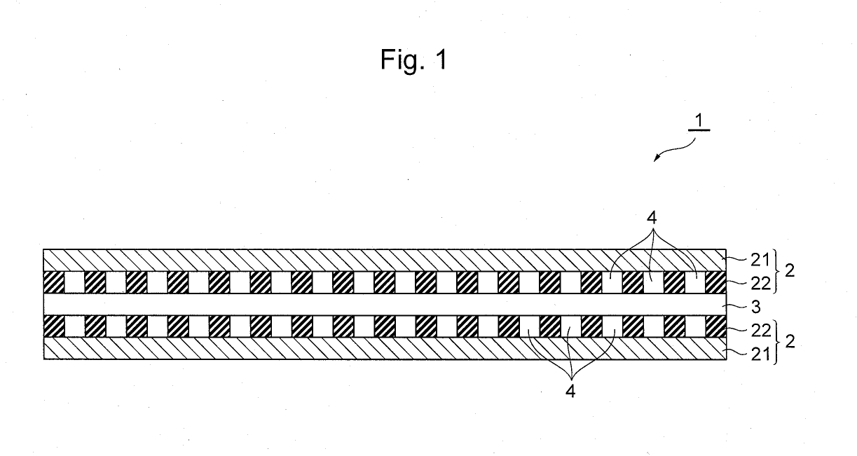

FIG. 1 is a schematic cross-sectional view of a fuel cell 1. The fuel cell 1 includes a pair of separators 2, and a MEGA 3 (Membrane-Electrode-Gas Diffusion Layer Assembly) disposed between these separators 2, for example. The MEGA 3 includes the lamination of a catalyst layer, a water-repellent layer, and a gas diffusion layer on the surface and the rear face of a polymer electrolyte membrane.

Each separator 2 for fuel cell includes a metal substrate 21 and a conduit-defining part 22 on the surface of this metal substrate 21. The metal substrate 21 is a metal plate-like member made of titanium or titanium alloy or made of a stainless steel, such as SUS316 or SUS447. The metal substrate 21 has a desired shape obtained by press forming or die-cutting, for example.

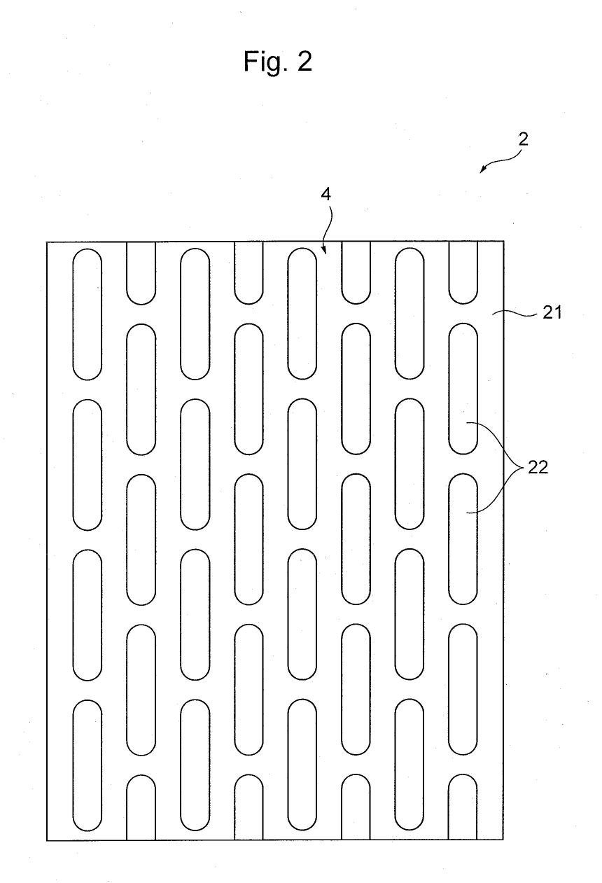

FIG. 2 is a schematic enlarged plan view of the surface of the separator 2 in FIG. 1. The conduit-defining part 22 includes a rib on the surface that is opposed to the MEGA 3 of the metal substrate 21, for example. The conduit-defining part 22 may include a protrusion protruding from the surface of the metal substrate 21 that is opposed to the MEGA 3 toward the MEGA 3, for example. The conduit-defining part 22 defines a gas conduit 4 between the separator 2 and the MEGA 3.

The fuel cell includes a fuel cell stack including the lamination of a plurality of fuel cells 1, i.e., single cells, and a housing to store the fuel cell stack, for example. Although not illustrated, the fuel cell 1 has a resin frame around the MEGA 3, for example, and the outer edges of the pair of separators 2 are joined via this resin frame. The pair of separators 2 and the resin frame have a plurality of manifold holes at the outer edges.

The fuel cell generates electricity while receiving reactant gas and coolant supplied via the manifold holes at the individual fuel cells 1 as components of the fuel cell stack. The reactant gas supplied to the fuel cell 1 via the manifold hole for supplying reactant gas is then supplied to the gas conduit 4 between the separator 2 and the MEGA 3 via a groove-like conduit formed at the outer edge of the resin frame, for example.

Reactant gas, which was supplied to the gas conduit 4 of the fuel cell 1 and was not used for the reaction at the MEGA 3, is discharged from the gas conduit 4 to the manifold hole for discharging reactant gas via a groove-like conduit formed at the outer edge of the resin frame, for example. Coolant, which is supplied to the manifold hole for supplying coolant of the fuel cell 1, is then supplied to a coolant conduit between the separators 2 of the neighboring fuel cells 1 as components of the fuel cell stack. Coolant is then discharged from the manifold hole for discharging coolant.

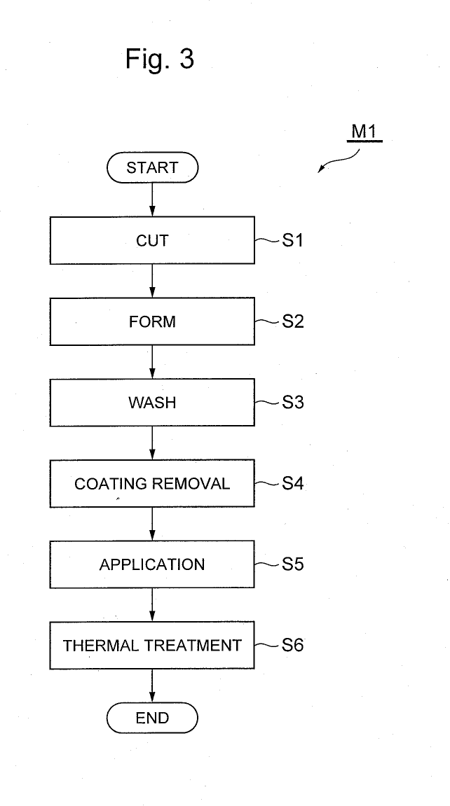

FIG. 3 is a flowchart of a method M1 for manufacturing a separator for fuel cell according to the present embodiment. As shown in FIGS. 1 and 2, the method M1 for manufacturing a separator for fuel cell of the present embodiment manufactures a separator 2 for fuel cell that includes the metal substrate 21 and the conduit-defining part 22 on the surface of the metal substrate 21, for example.

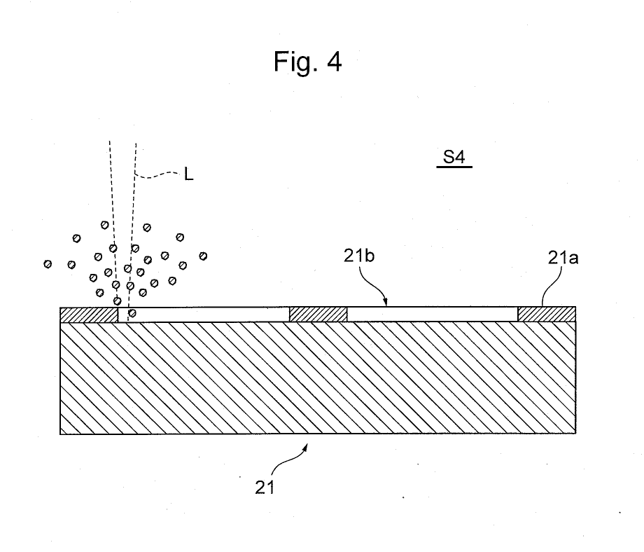

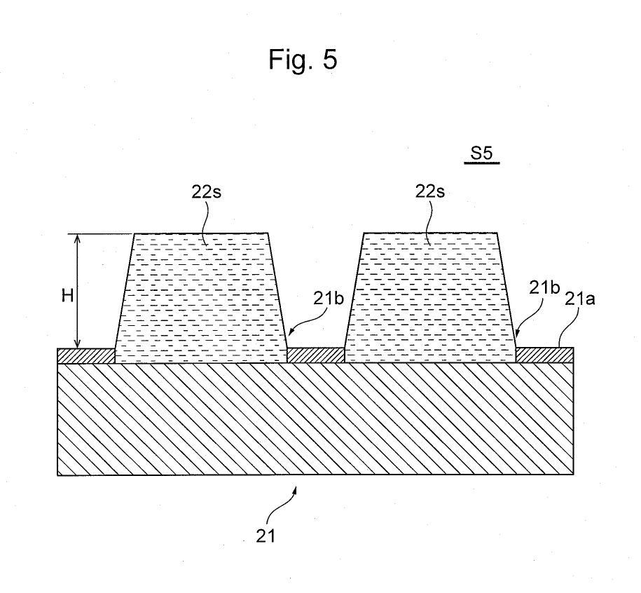

The method M1 for manufacturing a separator for fuel cell of the present embodiment, which will be described later in details, includes: a coating removal step S4 (see FIG. 4) to partially remove an oxide coating 21a covering the surface of the metal substrate 21 to form an application part 21b; an applying step S5 (see FIG. 5) to apply slurry 22s at the application part 21b after removing the oxide coating 21a; and a thermal treatment step S6 to heat the slurry 22s applied at the application part 21b to form a conduit-defining part 22.

The method M1 for manufacturing a separator for fuel cell may include, prior to the coating removal step S4, a cutting step S1 to cut the metal substrate 21 from a base material, a forming step S2 to form the metal substrate 21 cut at the cutting step S1, and a washing step S3 to wash the metal substrate 21, for example.

The cutting step S1 unwinds a metal thin plate from the roll as a base material, cuts it to be a metal substrate 21 in a desired shape, and then die-cuts such a cut metal substrate 21 to have a plurality of manifold holes, for example. The forming step S2 presses the metal substrate 21 subjected to the cutting step S to form the metal substrate 21 into a desired shape, for example.

The washing step S3 immerses the metal substrate 21 in acid solution, for example, to wash and remove the oxide adhering to the surface of the metal substrate 21. The washing step S3 does not remove the oxide coating 21a on the surface of the metal substrate 21 completely, and the metal substrate 21 after the washing step S3 still has the oxide coating 21a on the surface. The washing step S3 may include water-washing, for example, before or after the washing with oxide to immerse the metal substrate 21 in acid solution.

FIG. 4 is a schematic enlarged cross-sectional view of the metal substrate 21 to describe one example of the coating removal step S4 in FIG. 3. As described above, the coating removal step S4 partially removes the oxide coating 21a covering the surface of the metal substrate 21 to form the application part 21b. In other words, the application part 21b is a part of the metal substrate 21 having the oxide coating 21a on the surface, from which the oxide film 21a on the surface has been selectively removed.

At the coating removal step S4, the oxide coating 21a can be removed by laser cleaning using laser light L, such as YAG laser. More specifically the coating removal step S4 irradiates the oxide coating 21a covering the surface of the metal substrate 21 with laser light L while scanning over the area where the conduit-defining part 22 is to be formed, so as to selectively remove the oxide film 21a at the area and form the application part 21b.

In this way, the coating removal step S4 removes the oxide coating 21a on the surface of the metal substrate 21 with laser light L to form the application part 21b, whereby this step can selectively remove the oxide coating 21a only on the surface of the metal substrate 21. This is because the laser light L is reflected from a newly formed surface of the metal substrate 21 that is exposed at the application part 21b after removing the oxide coating 21a. At the coating removal step S4, the oxide coating 21a may be removed by sandblasting instead of laser cleaning, for example.

The application part 21b where the oxide coating 21a on the surface of the metal substrate 21 is removed has wettability better than wettability of the oxide coating 21a on the surface of the metal substrate 21. In other words, the application part 21b of the metal substrate 21 has a contact angle with pure water that is smaller than that of the oxide coating 21a. That is, the coating removal step S4 partially removes the oxide coating 21a covering the surface of the metal substrate 21 to form the application part 21b having wettability better than that of the oxide coating 21a. In other words, the method M1 for manufacturing a separator for fuel cell of the present embodiment includes the coating removal step S4 to form the application part 21b, and through this step, the application part 21b has a contact angle with pure water that is smaller than the contact angle with pure water at the oxide coating 21a.

FIG. 5 is a schematic cross-sectional view of the metal substrate 21 when the applying step S5 in FIG. 3 ends. As described above, the applying step S5 applies slurry 22s to the application part 21b after removing the oxide coating 21a. A method for applying the slurry 22s at the applying step S5 is not limited especially, and various methods, such as screen printing, gravure printing, slot die printing, offset printing, and inkjet printing, may be used.

The slurry 22s may be prepared, for example, by mixing graphite, acetylene black (carbon black), polyvinyl alcohol (PVOH) and binder with solvent including the mixture of water and ethylene glycol-2-n butylether. The solvents may include ethanol, propylene glycol, ethylene glycol and xylene.

As shown in FIG. 5, the oxide coating 21a on the surface of the metal substrate 21 is removed at the application part 21b on the surface of the metal substrate 21, so that the application part can have improved wettability as compared with the surrounding oxide coating 21a, and is slightly recessed from the surface of the oxide coating 21a. With this configuration, the slurry 22s applied to the application part 21b can be held at the application part 21b and does not spread over the surrounding area for wetting. In this way, the slurry can keep a predetermined shape and a necessary height H. From the viewpoint of securing a necessary cross-sectional area for the gas conduit 4 defined by the conduit-defining part 22, the slurry 22s applied at the application part 21b has to have a height H of 0.3 [mm] or more from the surface of the metal substrate 21, for example.

As described above, the thermal treatment step S6 heats the slurry 22s applied at the application part 21b on the surface of the metal substrate 21 to form the conduit-defining part 22. This thermal treatment step S6 vaporizes the solvent included in the slurry 22s applied at the application part 21b on the surface of the metal substrate 21 to form the conduit-defining part 22 on the surface of the metal substrate 21. As a result, the separator 2 for fuel cell as shown in FIGS. 1 and 2 can be manufactured.

As stated above, the method M1 for manufacturing a separator for fuel cell of the present embodiment can hold the shape of the slurry 22s applied on the surface of the metal substrate 21 and so form the conduit-defining part 22 of a predetermined thickness on the surface of the metal substrate 21.

That is a detailed description of the embodiments of the present disclosure. The specific configuration of the present disclosure is not limited to the above-stated embodiment, and the design may be modified variously without departing from the spirits of the present disclosure. The present disclosure also covers such modified embodiments. For instance, the oxide coating 21a covering the surface of the metal substrate 21 may be a plated layer covering the surface of the metal substrate 21.

More specifically, the method M1 for manufacturing a separator for fuel cell in this case manufactures a separator for fuel cell having a metal substrate 21 and a conduit-defining part 22 on the surface of the metal substrate 21. The method may include: partially removing a plated layer covering the surface of the metal substrate 21 to form an application part 21b; applying slurry 22s at the application part 21b after removing the plated layer, and heating the slurry 22s applied at the application part 21b to form a conduit-defining part 22. In this case, the plated layer may be a metal layer made of gold (Au), for example.

### Examples

The following describes Examples of the method for manufacturing a separator for fuel cell described in the above embodiment.

Three thin plates of pure titanium were prepared, which were metal substrates N11, N12 and N13 of Example 1. Three thin plates of stainless steel (SUS316) were prepared, which were metal substrates N21, N22 and N23 of Example 2. Next, the coating removal step was performed to partially remove the oxide coating covering the surface of each of the prepared metal substrates N11, N12, N13, N21, N22 and N23 and form the application part.

At the coating removal step, a laser device was used so that a part of the oxide coating covering the surface of each of the metal substrates N11, N12, N13, N21, N22 and N23 was irradiated with pulsed YAG laser with the average power of 150 [W] while scanning the laser at the scanning rate of 10 [m/min] with a galvanometer mirror. Next, contact angles [°] with pure water were measured at the oxide coating and at the application part for the metal substrates N11, N12 and N13 of Example 1 and the metal substrates N21, N22 and N23 of Example 2.

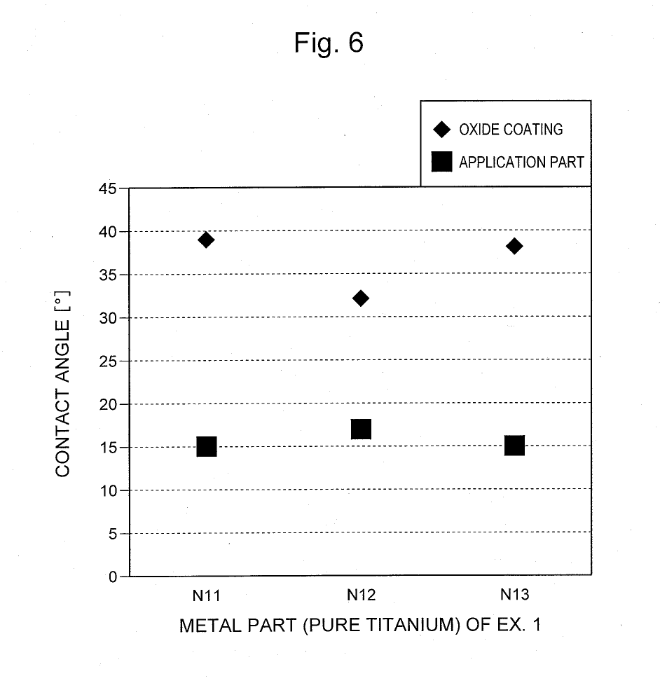

FIG. 6 is a graph showing the contact angles [°] with pure water at the oxide coating and at the application part for the metal substrates N11, N12 and N13 of Example 1. The metal substrates N11, N12 and N13 of Example 1 had contact angles with pure water at the oxide coating of 39[°], 32[°] and 38[°], respectively. The metal substrates N11, N12 and N13 had contact angles with pure water at the application part after removing the oxide coating on the surface of 15[°], 17[°] and 15[°], respectively.

That is, while the metal substrates N11, N12 and N13 made of pure titanium of Example 1 had contact angles with pure water at the oxide coating on the surface of 30[°] or more, the contact angles with pure water at the application part after removing the oxide coating decreased to less than 20[°]. That is, the contact angles with pure water at the application parts was 0.67 time or less the contact angles with pure water at the oxide coating of the metal substrates. Table 1 shows the result.

TABLE 1

| | |
|---|---|
| Metal substrate | Contact angle with pure water [°] |

| (Ex. 1) | Material | Oxide coating | Application part |
|---|---|---|---|
| N11 | Ti | 39 | 15 |
| N12 | Ti | 32 | 17 |
| N13 | Ti | 38 | 15 |

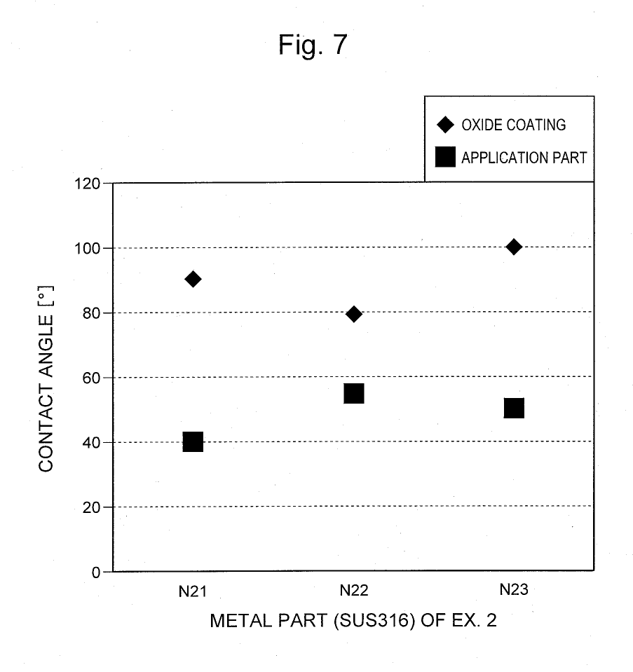

FIG. 7 is a graph showing the contact angles [°] with pure water at the oxide coating and at the application part for the metal substrates N21, N22 and N23 of Example 2. The metal substrates N21, N22 and N23 of Example 2 had contact angles with pure water at the oxide coating on the surface of 90[° ], 79[] and 100[° ], respectively. The metal substrates N21, N22 and N23 had contact angles with pure water at the application part after removing the oxide coating on the surface of 40[° ], 55[°] and 50[° ], respectively.

That is, while the metal substrates N21, N22 and N23 made of SUS316 of Example 2 had contact angles with pure water at the oxide coating on the surface of 75[°] or more, the contact angles with pure water at the application part after removing the oxide coating decreased to 55[°] or less. That is, the contact angles with pure water at the application parts was 0.75 time or less the contact angles with pure water at the oxide coating of the metal substrates. Table 2 shows the result.

TABLE 2

| | |
|---|---|
| Metal substrate | Contact angle with pure water [°] |

| (Ex. 2) | Material | Oxide coating | Application part |
|---|---|---|---|
| N21 | SUS316 | 90 | 40 |
| N22 | SUS316 | 79 | 55 |
| N23 | SUS316 | 100 | 50 |

Next slurry to be applied at the application part of the metal substrates was prepared. The slurry was prepared by mixing 85 weight parts of graphite, 15 weight parts of acetylene black (carbon black), 5 weight parts of polyvinyl alcohol (PVOH) and 3 weight parts of binder with solvent including the mixture of 49.5 weight parts of water and 5 weight parts of ethylene glycol-2-n butylether.

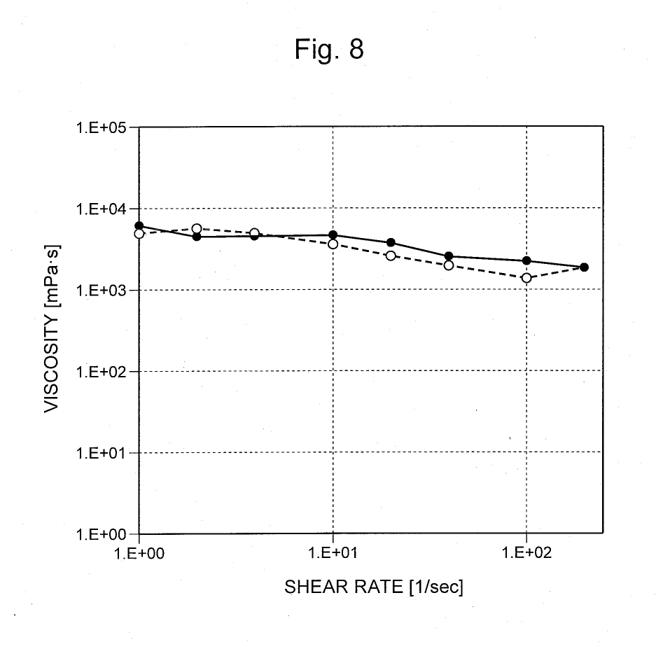

FIG. 8 is a graph showing the relationship between the shear rate [l/sec] and the viscosity [mPa·s] of the prepared slurry. As shown in FIG. 8, the slurry was non-Newtonian fluid, and showed the behavior of Bingham fluid. The slurry had the viscosity of 1×10³[mPa·s] or more and 1×10⁴[mPa·s] or less when the shear rate was within the range of 1×10²[l/sec] or less.

Next, the applying step was performed to apply the slurry to the application part of each of the metal substrates N11, N12, N13, N21, N22 and N23 after removing the oxide coating by screen printing. The screen printing was performed under the conditions of the speed of the squeegee of 30 [mm/sec], the angle of the squeegee of 70[° ], the printing pressure of 0.3 [Mpa], and the rubber hardness of the squeegee of 70 degrees using a durometer (type A). A pre-contact squeegee was not used. As shown in FIG. 5, the slurry applied at the application parts of each of the metal substrates N11, N12, N13, N21, N22 and N23 held a predetermined shape having the height H of 0.3 [mm] or more.

Next, the thermal treatment step was performed to heat the slurry applied at the application part of each of the metal substrates N11, N12, N13, N21, N22 and N23 to form the conduit-defining part. At the thermal treatment step, the slurry was heated for drying under the conditions of 130[° C.] and 30 [sec], and the conduit-defining part 22 was formed as shown in FIGS. 1 and 2.

The separators of Example 1 and Example 2 obtained through these steps successfully had the conduit-defining part 22 having a predetermined thickness on the surface of the metal substrates N11, N12, N13, N21, N22 and N23. The separators for fuel cell of Example 1 and Example 2 therefore had sufficient cross-sectional area of the gas conduit 4 defined with the conduit-defining part 22 so as to improve the power generation efficiency of the fuel cell and have good fuel efficiency.

### Comparative Examples

Thin plates of pure titanium and stainless steel (SUS316) were prepared, which were metal substrates of Comparative Example 1 and Comparative Example 2, respectively. Oxide coating covering the surface of the metal substrates of Comparative Examples 1 and 2 was not removed, and the slurry prepared similarly to Examples was applied by screen printing on the surface of the metal substrates of Comparative Examples 1 and 2.

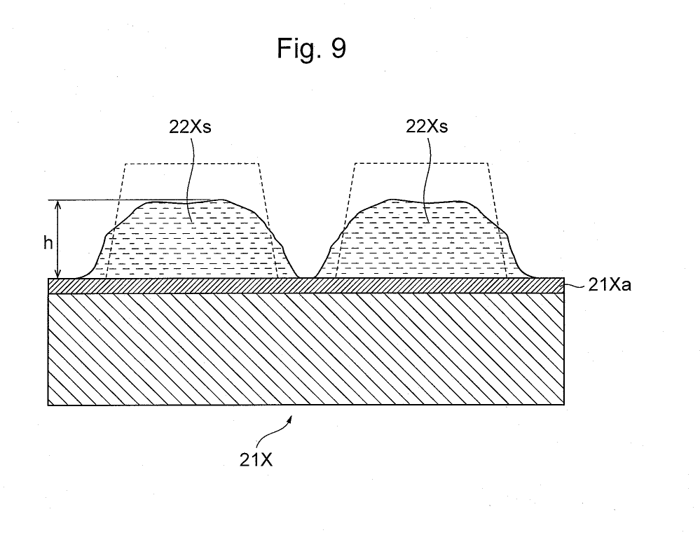

FIG. 9 is a schematic cross-sectional view of the slurry 22Xs applied to the metal substrate 21X of Comparative Examples 1 and 2. The slurry 22Xs applied to the metal substrate 21X of Comparative Examples 1 and 2 had ooze spreading to the surrounding over the oxide coating 21Xa on the surface, and the height H was less than 0.3 [mm]. In this way the slurry failed to hold a predetermined shape.

Next, the thermal treatment step was performed to heat the slurry 22Xs applied at the application part of each of the metal substrates of Comparative Examples 1 and 2 to form the conduit-defining part. The thermal treatment step was performed similarly to Examples. The separators of Comparative Examples 1 and 2 obtained through these steps failed to form the conduit-defining part having a predetermined thickness on the surface of the metal substrates.

The separators of Comparative Examples 1 and 2 therefore failed to have a sufficient cross-sectional area of the gas conduit defined with the conduit-defining part, which may cause deterioration of the power generation efficiency of the fuel cell and of the fuel efficiency.

### DESCRIPTION OF SYMBOLS

21 Metal substrate
22 Conduit-defining part
21a Oxide coating
21b Application part
22 Conduit-defining part
22s Slurry
L Laser light
M1 Method for manufacturing separator for fuel cell
S4 Coating removal step (step to form application part)
S5 Applying step (step to apply slurry)
S6 Thermal treatment step (step to form conduit-defining part)

What is claimed is:

1. A method for manufacturing a separator for fuel cell including a metal substrate and a conduit-defining part on a surface of the metal substrate, the method comprising:
partially removing oxide coating covering the surface of the metal substrate to form an application part;
applying slurry to the application part after removing the oxide coating; and
heating the slurry applied at the application part to form the conduit-defining part.

2. The method for manufacturing a separator for fuel cell according to claim 1, wherein the forming of the application part makes a contact angle with pure water at the application part smaller than a contact angle with pure water at the oxide coating.

3. The method for manufacturing a separator for fuel cell according to claim 1, wherein the forming of the application part removes the oxide coating with laser light.

4. The method for manufacturing a separator for fuel cell according to claim 2, wherein the contact angle with pure water at the application part is 0.75 times or less the contact angle with pure water at the oxide coating.

5. The method for manufacturing a separator for fuel cell according to claim 4, wherein the metal substrate is made of pure titanium, and
the contact angle with pure water at the application part is less than 20[° ].

6. The method for manufacturing a separator for fuel cell according to claim 4, wherein the metal substrate is made of stainless steel, and
the contact angle with pure water at the application part is less than 60[° ].

7. The method for manufacturing a separator for fuel cell according to claim 5, wherein the slurry has viscosity of 1×10³[mPa·s] or more and 1×10⁴[mPa·s] or less when shear rate is within the range of 1×10²[l/sec] or less.

8. The method for manufacturing a separator for fuel cell according to claim 2, wherein the forming of the application part removes the oxide coating with laser light.

9. The method for manufacturing a separator for fuel cell according to claim 6, wherein the slurry has viscosity of 1×10³[mPa·s] or more and 1×10⁴[mPa·s] or less when shear rate is within the range of 1×10²[l/sec] or less.
